(19) United States
(12) Patent Application Publication
(10) Pub. No.: US 2014/0150531 A1
(43) Pub. Date: Jun. 5, 2014

(54) SELECTIVELY SEALABLE PIPE STUB

(71) Applicant: WCM Industries, Inc., Colorado Springs, CO (US)

(72) Inventor: William T. Ball, Colorado Springs, CO (US)

(73) Assignee: WCM Industries, Inc., Colorado Springs, CO (US)

(21) Appl. No.: 14/071,377

(22) Filed: Nov. 4, 2013

Related U.S. Application Data
(60) Provisional application No. 61/722,756, filed on Nov. 5, 2012.
(60) Provisional application No. 61/780,191, filed on Mar. 13, 2013.

(51) Int. Cl. G01M 3/02

(52) U.S. Cl. CPC G01M 3/022
USPC 73/40.5 R; 285/119; 285/355

(57) ABSTRACT

A pipe stub is provided that includes an elongated cylindrical portion that is selectively sealed on one end. For example, the cylindrical portion may be selectively sealed with a removable diaphragm. In operation, after the pipe stub is interconnected to a plumbing system and a leak test is completed, the plumber severs show otherwise circumvents the diaphragm to open the pipe stub, which can be used to receive additional plumbing components.

This application claims the benefit of U.S. Provisional Patent Application Ser. No. 61/722,756, filed Nov. 5, 2012, the entire disclosure of which is incorporated by reference herein.

### FIELD OF THE INVENTION

Embodiments of the present invention are generally related to pipe stubs that are used to selectively seal portions of a plumbing system being tested.

### BACKGROUND OF THE INVENTION

Plumbing systems of new or existing buildings are commonly leak tested. Further, those of skill in the art appreciate that the plumbing system of a new building is tested numerous times during construction. For example, after basement plumbing is “roughed in” and before a concrete floor is poured, all openings in the plumbing system are sealed or otherwise blocked. Next, that portion of the plumbing system is filled with water and a hydrostatic pressure test is performed wherein the pipes are pressurized about 5 to 15 psi. The tested portion is inspected to identify any leaks. After the basement test is complete, the other floors of the building are tested in the same manner. When all tests are complete, the plumbing system is finished by interconnecting sinks, bathtubs, etc., to the various openings of the plumbing system that were blocked during the test.

Currently, caps or plugs are used to block or seal all but one of the openings in the plumbing system or a segment thereof. In operation, the plugs are inserted into the pipe, the plumbing system is tested, and the plugs are removed so that the plumbing system can be finished. One common test plug is comprised of an expandable elastomeric material that is positioned between two metallic members that when compressed expands to engage an inner surface of the pipe to seal the same. FIGS. 1-3 show a plug 2 of the prior art that is comprised of a first plate 6 separated from a second plate 10 by an elastomeric member 14. A bolt 18 spans between the first plate 6 and the second plate 10 wherein one end of the bolt 18 is secured to the first plate 6. A nut 22, which may be spaced from the second plate 10 with a washer 26, is also interconnected to the bolt 18. In operation, as the nut 22 is tightened, the first plate 6 is drawn towards the second plate 10 which compresses the elastomeric member 14 longitudinally and expands it laterally as shown in FIG. 2. In the expanded state, the edge of the elastomeric member 14 will firmly engage the inner surface 30 of a pipe stub 34 that has been interconnected via adhesive to an opening, i.e., a tee connector 38, of the plumbing system. The plug 2 is removed by loosening the nut 22 which relaxes the elastomeric member 14.

One disadvantage using a plug is that it can be difficult to position and align within the pipe stub, which could cause a loss in pressure during the test which could be mistaken as a leak. Further, it is difficult and some instances to insert tools into the stub to tighten the nut or other mechanism that biases the first plate towards second plate. The greatest drawback is that plugs that are traditionally used are expensive, often costing $20 or more. One of skill in the art will appreciate that in a large high-rise building, for example, many plugs are required which increases plumbing costs. Another drawback is that plugs are often lost. More specifically, once the pressure test is complete, the pipe stub is severed between the plug and the tee connector. A portion of the pipe stub that remains interconnected to the tee is eventually interconnected to a plumbing fitting that leads to a sink or bathtub, for example. The unused portion of the pipe stub is commonly discarded where the plug is inadvertently discarded as well.

FIG. 4 shows another embodiment of the prior art wherein a cap 50 is used. Here, the pipe stub 54 is interconnected to a tee connector 58 by bonding or any other known methods. Again, a portion of the pipe stub 54 is designed to remain interconnected to tee 58 and later accepts an elbow, for example. The cap 50 is commonly interconnected to the open end 62 of the pipe stub 54 with adhesive. Thus one drawback of using caps is that the plumber must wait for the bonding agent to cure, which adds delays and complexity to the plumber's task. Furthermore, if the open end 62 of the pipe stub 54 is not adequately flush, i.e., has burrs or an uneven surface, the cap 50 may not bond correctly, which may lead to false indications of leakage when the plumbing system is tested. In addition, if the cap is of a different material than the pipe stub 54 (a mismatch between ABS and PVC, for example) bonding may not be ideal. Leak tests are often performed at pressures that would compromise PVC pipes, which crack or rupture when exposed to pressures as low as about 5 to 6 PSI. Ideally, and interconnected plug or cap would disengage from the pipe stub before the pipe stub or interconnected pipes fracture. In some instances, however, bonding between the cap and the pipe stub can withstand the increased test pressure and the cap will remain on an over pressurization situation.

Thus, is a long felt need in the field of plumbing to provide a method of quickly and cost-effective by sealing segments of a plumbing system for leak testing. The following disclosure describes an improved pipe stub that includes a diaphragm positioned adjacent to the open and of the pipe stub. Further, the contemplated pipe stub can be used multiple times for multiple leak tests, which reduce costs.

### SUMMARY OF THE INVENTION

It is one aspect of embodiments of the present invention to provide a pipe stub adapter with a removable diaphragm. More specifically, one embodiment of the present invention is a cylindrical pipe having a first end adapted to be secured to an opening in a plumbing system, and a second end with a removable diaphragm. The diaphragm may made out of plastic or any other similar material. The diaphragm is designed to be severed or otherwise removed from the pipe stub when testing is complete. The diaphragm may include a tab that is used to pull the diaphragm from the pipe stub or the diaphragm 80 can be cut from the pipe stub.

In operation, the pipe stub is interconnected to an opening in a plumbing system and the plumbing system is leak tested. After the test is complete, the pipe stub is severed such that the remaining pipe can receive an elbow, for example. The remaining portion of the pipe stub, which includes the diaphragm, is then used in subsequent leak tests. The diaphragm of one embodiment of the present invention is designed to withstand about 2-100 PSI, which corresponds to the maximum head pressure expected when a 3-story house is tested. The diaphragm is, thus, designed to withstand multiple leak tests performed at lower pressures. The pipe stub may be of sufficient length such that it can be used, cut, and reused a number of times. To prevent over pressurization of the plumbing system and the pipe stub, the diaphragm of one embodiment present invention is designed to rupture at a pressure below the yield pressure of PVC or ABS pipe. Diaphragm rupture may be facilitated by grooves or frangible areas incorporated into the diaphragm.

One of skill that will appreciate that the pipe stub may be closed on one end with features other than a diaphragm. For example, some embodiments of the present invention include a convex or a concave second end that is not elastomeric or flexible as described above. In this example, a rigid end is sonically welded, bonded, or otherwise interconnected to the pipe stub. Other embodiments of the present invention include sealing features that are integrally manufactured into the pipe stub.

One embodiment of the present invention has a closed end that is frangible. For example, the end may possess an edge of reduced thickness that is interconnected to the inner surface or outer edge of the pipe stub. The plumber removes the end with a hammer, for example, when it is no longer needed. In other embodiments of the present invention, at least a portion of the outer surface of the pipe is comprised of threads that receive a cap. The cap may also be interconnected to the pipe stub by way of a bayonet fitting or any other common selective, nonpermanent interconnection mechanism known in the art.

It is yet another aspect the present invention provides a pipe stub with an outer surface with identifying indicia. For example, the identifying indicia may include a series of markings indicating tube length which helps the plumber assess how far to insert the pipe stub into the tee, and how far the pipe stub should extend beyond the tee after the test is complete, for example. In addition, the end and/or sides of the pipe stub, may include the manufacturer's trademark or other markings Such markings may be molded into the pipe stub or end wall, for example. The markings may be also be used to provide a visual notification to the plumber that and otherwise innocuous piece of plumbing to be discarded is a pipe stub that can be used in a subsequent pressure test. The markings may also be used as a visual indicator that the plot pipe stub is interconnected to the plumbing system so that finished plumbing fixtures are not prematurely installed.

Thus, it is one aspect of the present invention to provide a member for interconnection to a fluid delivery or fluid waste system, comprising: a cylindrical pipe stub having a first end and a second end, the first end being adapted for interconnection to the fluid delivery or fluid waste system; and a diaphragm associated with the second end of the pipe stub.

It is yet another aspect of the present invention to provide a member for interconnection to a fluid delivery or fluid waste system, comprising: a pipe stub having a first end and a second end, the first end being adapted for interconnection to the fluid delivery or fluid waste system; and a closure member associated with the second end of the pipe stub.

It is another aspect of the present invention to provide a method of selectively blocking fluid flow through a fluid delivery or fluid waste system, comprising: providing a hollow pipe stub adapter having a first length defined by a first end and a second end, the second end having a closure member associated therewith; interconnecting the first end of the pipe stub to a first opening in the fluid delivery or fluid waste system; performing a first leak test of the fluid delivery or fluid waste system; cutting the pipe stub to create a second pipe stub of a second length; interconnecting the second pipe stub to a second opening in the fluid delivery or fluid waste system; performing a second leak test of the fluid delivery or fluid waste system; and cutting the pipe stub to create a third pipe stub of a third length.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a side elevation view of a plug of the prior art;

FIG. 2 is the plug shown in FIG. 1 wherein an elastomeric member positioned between two end plates has been expended outwardly;

FIG. 3 is a cross-sectional view of a plumbing system that is interconnected to a pipe stub that is sealed with a plug;

FIG. 4 is a cross-sectional view of a plumbing system with a pipe stub interconnected thereto that is sealed with a cap;

FIG. 5 is a perspective view of a pipe stub of one embodiment of the present invention that is sealed on one end with a diaphragm;

FIG. 6 is a cross-sectional view of FIG. 5;

FIG. 7 is a cross-sectional view of a pipe stub that is interconnected to a tee connector;

FIG. 8 is a cross-sectional view of a tee interconnected to elbow via a remaining portion of the pipe stub;

FIG. 9 is a cross-sectional view of a shortened pipe stub interconnected to a tee;

FIG. 10 is a cross-sectional view of a pipe stub employing a convex end;

FIG. 11 is a cross-sectional view of a pipe stub employing a convex end with a dimple;

FIG. 12 is a cross-sectional view of a pipe stub employing a concave end;

FIG. 13 is a cross-sectional view of a pipe stub employing an inwardly-disposed wall;

FIG. 14 is a cross-sectional view of a pipe stub having a inwardly-disposed frangible wall;

FIG. 15 is a cross-sectional view of a cross-sectional view of a pipe stub having a plurality threads that receive a sealing cap;

FIG. 16 is a cross-sectional view of a cross-sectional view of a pipe stub that is selectively closed by a frangible wall; and

FIG. 17 is a cross-sectional view of a pipe stub adapter having a plurality of outwardly and inwardly extending notches.

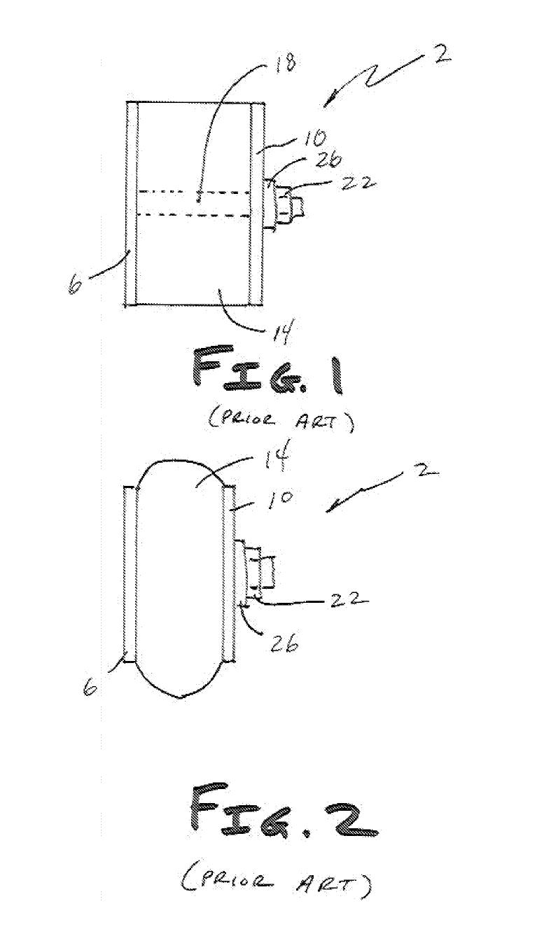

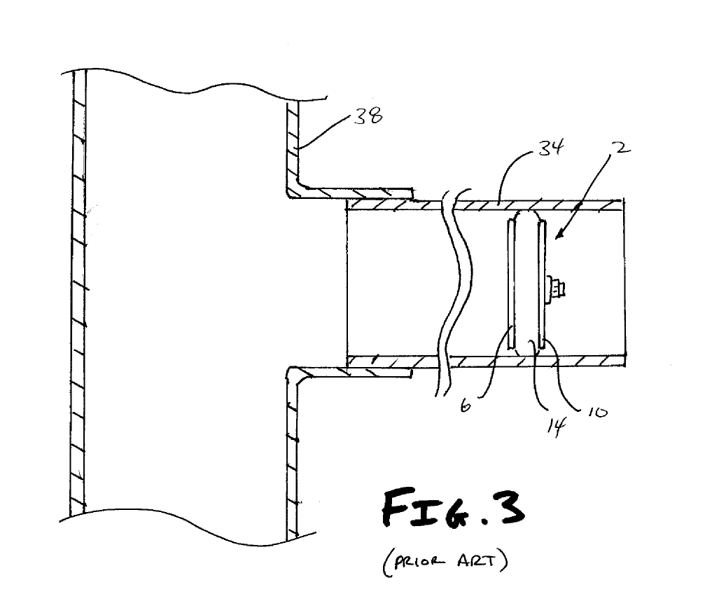

To assist in the understanding of one embodiment of the present invention the following list of components and associated numbering found in the drawings is provided herein:

# Component

2 Plug

6 First plate

10 Second plate

14 Elastomeric member

18 Bolt

22 Nut

26 Washer

30 Inner surface

34 Pipe stub

38 Tee connector

50 Cap

54 Pipe stub

58 Tee connector

62 Open-end

70 Pipe stub

74 First end

78 Second end

82 Tee connector

86 Diaphragm

90 Elbow

94 Shortened pipe stub

100 Pipe stub

102 Closed-end

110 Dimple

114 Concave

200 Pipe stub

204 Wall

# Component

208 Second end

212 First end

216 Outer edge

220 Inner surface

300 Pipe stub

304 Outer surface

308 Threads

312 Cap

400 Pipe stub

404 Wall

408 second end

412 Thinned portion

500 Pipe stub

504 Diaphragm

508 Inner notch

512 Outer notch

516 Thinned portion

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

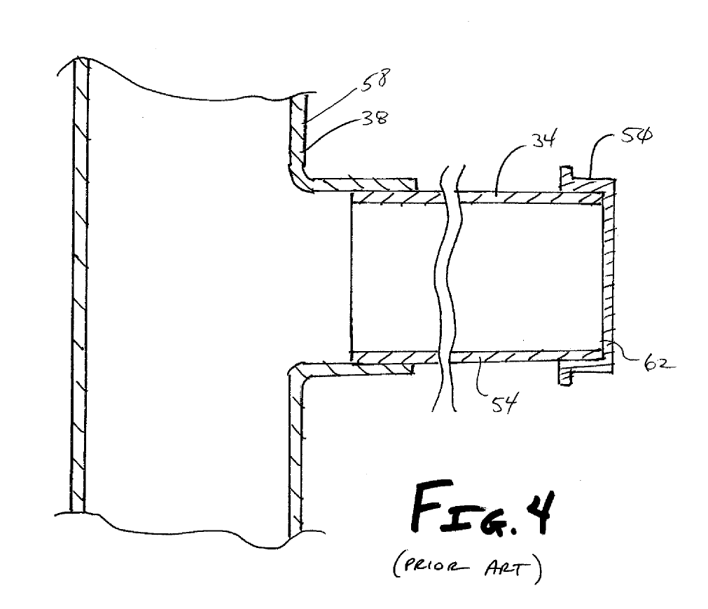

Referring now to FIGS. 5-9, one embodiment of a pipe stub 70 is shown that has a first end 74 and a second and 78. The first end 74 is adapted for interconnection to a portion of a plumbing system, such as a tee connector 82. The second end 78 of the pipe stub 70 is closed with a diaphragm 86 to prevent fluid flow through the pipe stub 70. In operation, the diaphragm 86 may be cut or otherwise removed from the pipe stub 70 to allow fluid flow through the pipe stub 70 after a leak test is performed. The pipe stub 70 can be of any length or diameter.

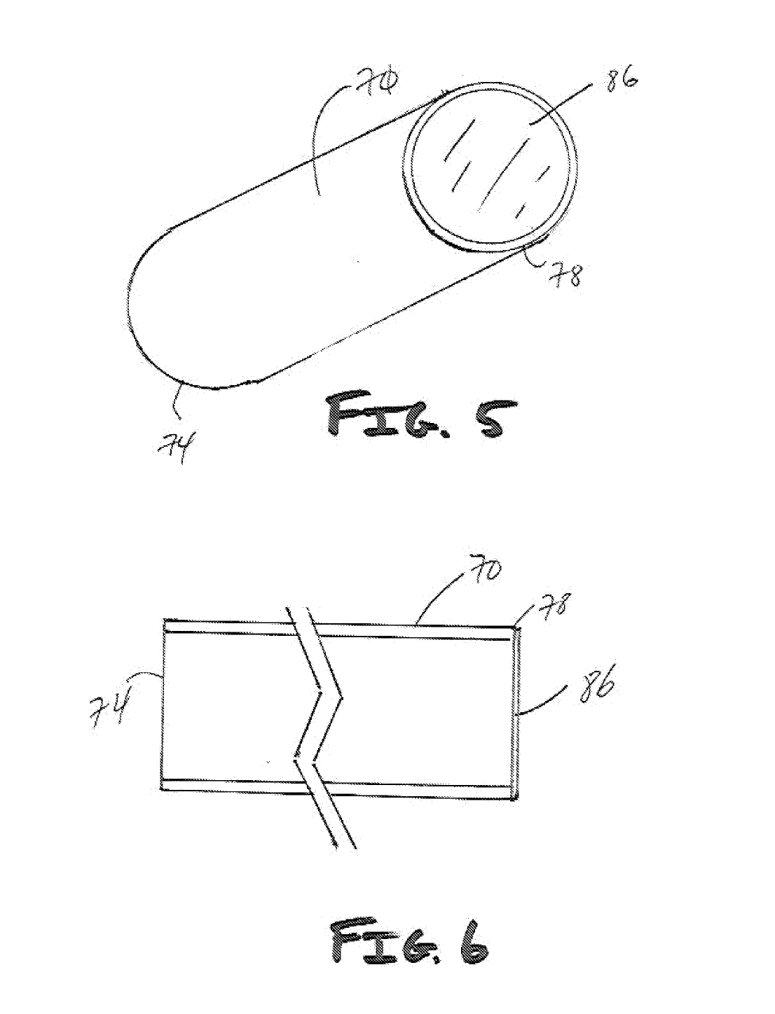

FIG. 7-9 show the pipe stub 70 interconnected to a portion of a plumbing system, in this instance, a tee connector 82. The first end 74 of the pipe stub 70 is inserted into the tee connector 82 and bonded thereto using known methods. Thus, the second end 78 of the pipe stub 70 is blocked with the diaphragm 86. After the leak tested performed, the pipe stub 70 is severed which leaves a portion of the pipe stub with a length (L2) shorter than the initial length of the pipe stub (L1). An elbow 90 or additional plumbing is eventually interconnected to the pipe. The elbow 90 is bonded to the pipe stub 70 using known techniques and adhesives.

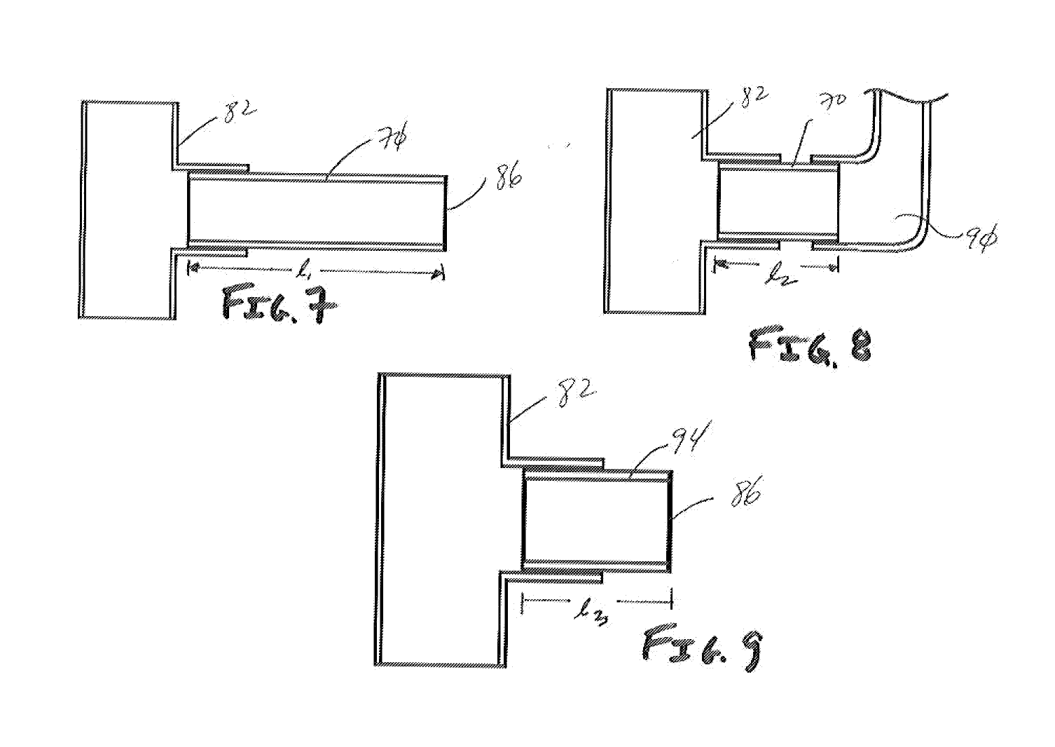

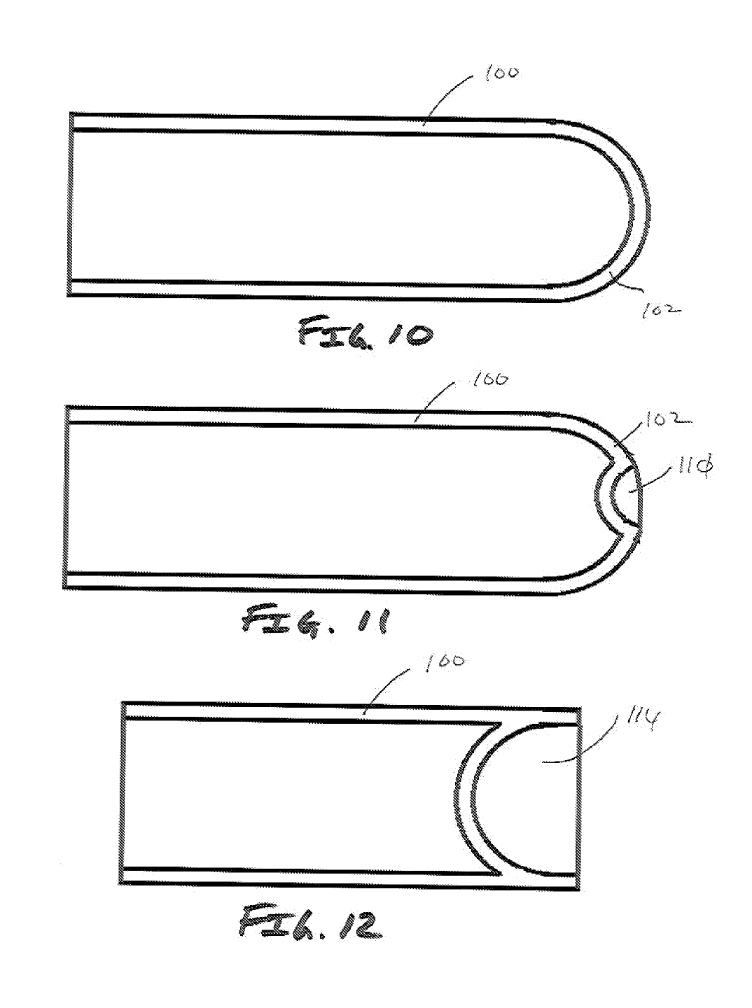

The shortened pipe stub 94 shown in FIG. 9 can be then interconnected to another tee connector 82 of the plumbing system. For example, after the initial leak tests are performed, the shortened pipe stub 94 is used to test other segments of the plumbing system of the same building or the plumbing system of other buildings, which reduce costs. Referring now again to FIG. 9, the pipe stub has a length of (L3), which is shorter than the length (L1) of the pipe stub. After all tests are complete, the end of the pipe stub 74 shortened pipe stub 94 may be severed or the diaphragm 86 may be ruptured and an elbow or other plumbing component may be interconnected to the stub pipe stub as shown in FIG. 8.

FIG. 10 shows another embodiment of the present invention wherein the pipe stub 100 is sealed with a convex end 102. The closed end 102 is bonded or integrally molded to the pipe stub 100. Similar to the process described above, this pipe stub 100 may be used in number of times wherein the length of the pipe stub 100 can be incrementally reduced after each test is complete. The closed end 102 of the pipe stub 100 may have a dimple 110 or possess indicia, such as the manufacturer's name, without departing from the scope of the invention. Further, as shown in FIG. 12, the closed and 102 of the pipe stub 100 may be concave 114.

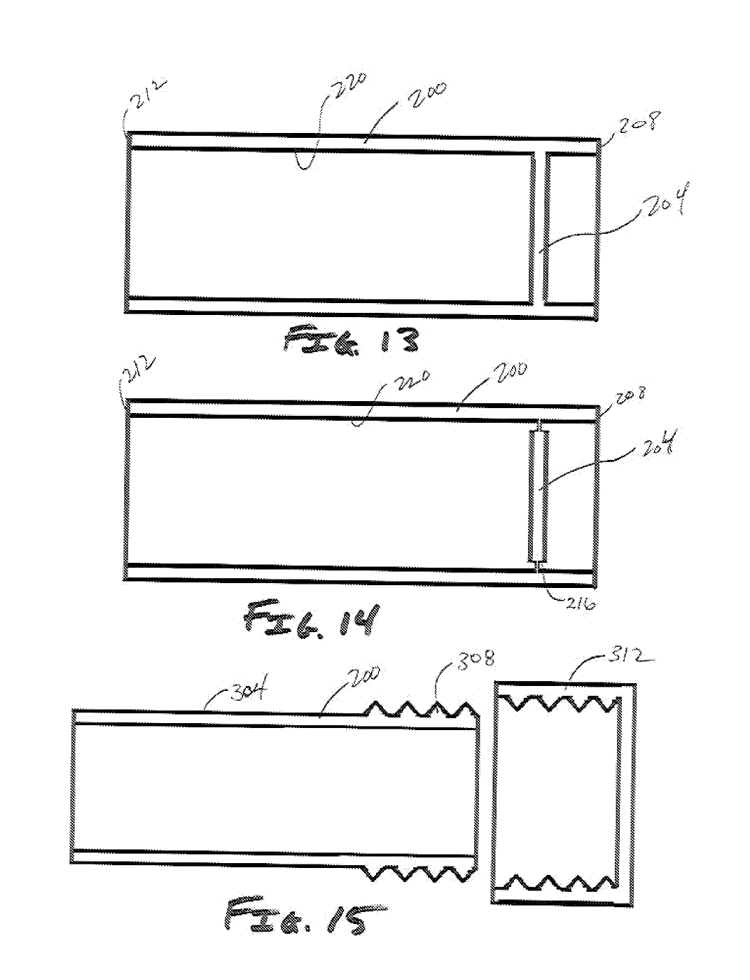

FIGS. 13 and 14 show yet other embodiments of the present invention where the pipe stub 200 is selectively blocked with a wall positioned at the second end 208 of the pipe stub 200 or between the first end 212 and the second end 208 of the pipe stub. In one embodiment of the present invention, the wall 204 is frangible. More specifically, the wall 204 may have an outer edge 216 that is integrated onto or interconnected to the inner surface 224 of the pipe stub 200. When the leak test is complete, the plumber may knock out to or otherwise disengage the frangible wall 204 from the inner surface 220 of the pipe stub 200 to provide an open fluid flow path.

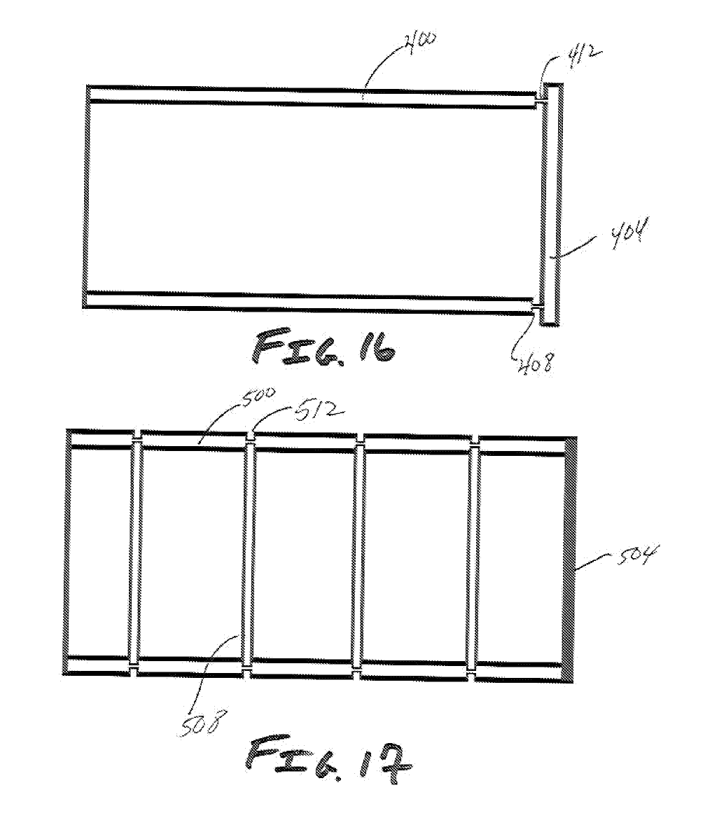

FIG. 15 shows yet another embodiment of the present invention where the pipe stub 300 has an outer surface 304 that is at least partially comprised of threads 308. In operation, a cap 312 is threadably engaged to the pipe stub 300 before the leak test is performed.

FIG. 16 is another embodiment of a pipe stub 400 that includes a frangible wall 404. Here, the frangible wall 404 is associated with the second end 408 of the pipe stub 400. Again, once the leak test is complete, the plumber may use a hammer and chisel or screwdriver to break the thinned portions 412 that interconnect the wall 404 to the second end of the pipe stub 400 to remove the frangible wall.

FIG. 17 shows another embodiment of the present invention that employs a diaphragm 504. However, one of skill that will appreciate other sealing methods as disclosed herein may be used. Here, the pipe stub 500 includes inner notches 508 and/or outer notches 512. The notches facilitate cutting of the pipe stub 500. For example, once leak test is complete, the plumber can cut through a notch 27 the pipe stub 500. The thinned portions 516 provided by the inner and/or outer notches facilitates cutting. The notches also act a length a length indicator which allows the plumber to quickly identify the length of the remaining pipe stub.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A member for interconnection to a fluid delivery or fluid waste system, comprising:
a cylindrical pipe stub having a first end and a second end, said first end being adapted for interconnection to the fluid delivery or fluid waste system; and
a diaphragm associated with said second end of said pipe stub.

2. The member of claim 1, wherein said pipe stub has a plurality of spaced notches extending about the outer periphery thereof

3. The member of claim 1, wherein said pipe stub has a plurality of spaced notches extending about the inner periphery thereof

4. The member of claim 1, wherein said pipe stub has a plurality of spaced notches extending about the outer periphery thereof and a plurality of notches extending about the inner periphery thereof

5. The member of claim 1, wherein said first end of said pipe stub is adapted to be inserted into a tee of the fluid delivery or fluid waste system.

6. A member for interconnection to a fluid delivery or fluid waste system, comprising:
a pipe stub having a first end and a second end, said first end being adapted for interconnection to the fluid delivery or fluid waste system; and
a closure member associated with said second end of said pipe stub.

7. The device of claim 6 wherein said closure member is a diaphragm.

8. The device of claim 6 wherein said closure member is a outwardly extending wall.

9. The device of claim 6 wherein said closure member is an inwardly extending wall.

10. The device of claim 6 wherein said closure member is a wall that is spaced from said second end of said pipe stub.

11. The device of claim 10 wherein said wall has an outer edge that is selectively interconnected to an inner surface of said pipe stub.

12. The device of claim 6 wherein said closure member is a cap that operably engages threads incorporated into the outer surface of said pipe stub.

13. The device of claim 6 wherein said closure member is a wall that is selectively interconnected to said second end of said pipe stub by a thinned wall portion.

14. The device of claim 6, wherein said pipe stub has a plurality of notches extending about the outer periphery thereof.

15. The device of claim 6, wherein said pipe stub has a plurality of notches extending about the inner periphery thereof.

16. The device of claim 6, wherein said pipe stub has a plurality of outer notches extending around the outer periphery thereof and a plurality of inner notches extending around the inner periphery thereof.

17. A method of selectively blocking fluid flow through a fluid delivery or fluid waste system, comprising:
providing a hollow pipe stub adapter having a first length defined by a first end and a second end, said second end having a closure member associated therewith;
interconnecting said first end of said pipe stub to a first opening in the fluid delivery or fluid waste system;
performing a first leak test of the fluid delivery or fluid waste system;
cutting said pipe stub to create a second pipe stub of a second length;
interconnecting said second pipe stub to a second opening in the fluid delivery or fluid waste system;
performing a second leak test of the fluid delivery or fluid waste system; and
cutting said pipe stub to create a third pipe stub of a third length.

18. The method of claim 17 wherein said pipe stub includes a plurality of notches about the outer perimeter thereof that facilitates cutting of said pipes stub.

19. The method of claim 18 wherein said closure member is a diaphragm, and further comprising:
interconnecting said third pipe stub to a third opening in the fluid delivery or fluid waste system;
performing a third leak test of the fluid delivery or fluid waste system; and
severing said diaphragm.
